(19) United States
(12) Patent Application Publication
(10) Pub. No.: US 2026/0338262 A1
(43) Pub. Date: Oct. 29, 2026

(54) POSITIONING DEVICE

(71) Applicant: DESTACO Europe GmbH, Oberursel (DE)

(72) Inventor: Patrick Robert METZ, Grossostheim (DE)

(73) Assignee: DESTACO Europe GmbH, Oberursel (DE)

(21) Appl. No.: 19/107,767

(22) PCT Filed: Aug. 29, 2023
(86) PCT No.: PCT/DE2023/100620

§ 371 Date: Feb. 28, 2025

(30) Foreign Application Priority Data
Sep. 1, 2022 (DE) 10 2022 122 108.3

(51) Int. Cl. F16H 21/16; F16H 57/00

(52) U.S. Cl. CPC F16H 21/16; F16H 57/00

(57) ABSTRACT

A positioning device includes a housing, an actuator mounted for linear movement in the housing, a stop provided on the actuator and a counter-stop that can be fixed in the housing and interacts with the stop to limit the stroke length of the actuator, wherein an insert opening for the counter-stop is provided in the housing. The counter-stop has two wedge elements that can be adjusted relative to each other and can thereby be fixed in the insert opening.

The invention relates to a positioning device according to the preamble of patent claim 1.

A positioning device of the above-mentioned type is known from the document DE 100 13 874A 1 . This positioning device, which, in the concrete case here, has a pivotable clamping arm, consists of a housing, an actuator mounted for linear movement in the housing, a stop provided on the actuator and a counter-stop, which can be fixed in the housing and interacts with the stop to limit the stroke length of the actuator, wherein an insert opening for the counter-stop is provided on the housing. In the case of this solution, a force introduced by the actuator into the counter-stop via the stop is introduced into the head piece of housing, respectively, via the travel limiter (see reference numeral 82 there) and the cover plate (see reference numeral 81 there).

The invention is based on the object of improving a positioning device of the above-mentioned type. In particular, a positioning device is to be created, in the case of which a force coming from the actuator is introduced better into the housing or is dissipated to the latter, respectively.

This object is solved with a positioning device of the above-mentioned type by means of the features listed in the characterizing portion of patent claim 1.

According to the invention, it is thus provided that the counter-stop has two wedge elements, which can be adjusted relative to one another and can thereby be fixed in the insert opening.

In other words, the solution according to the invention is thus characterized in that the combination of the insert opening in the housing and the two wedge elements, which can be suitably adjusted, forms the counter-stop for the stop arranged on the actuator—as solid assembly—. This combination leads to a very stable solution, in the case of which the counter-stop can additionally be adjusted very easily if necessary, which will be explained in more detail further below.

Other advantageous further developments of the positioning device according to the invention follow from the dependent patent claims.

The positioning device according to the invention, including its advantageous further developments according to the dependent patent claims, will be explained in more detail below on the basis of the graphic representation of a preferred exemplary embodiment, in which

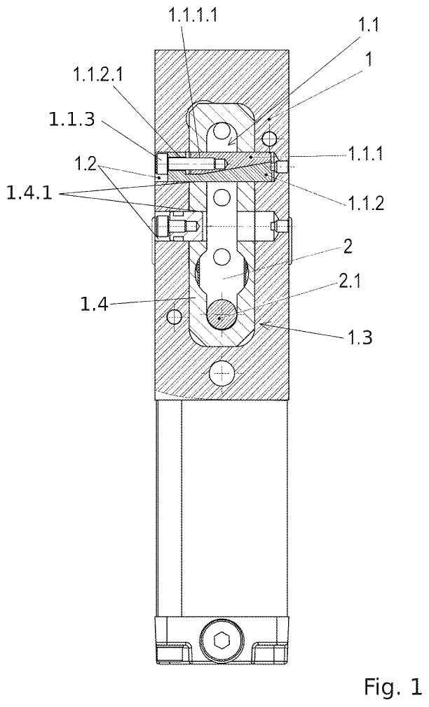

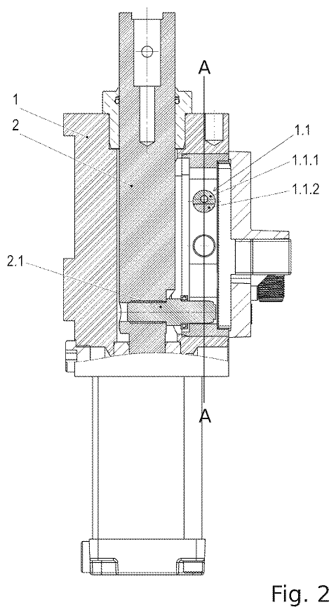

FIG. 1 shows, in section, the positioning device according to the invention in a rear view along the cutting line A-A in FIG. 2;

FIG. 2 shows, in section, the positioning device according to FIG. 1 in a cut side view;

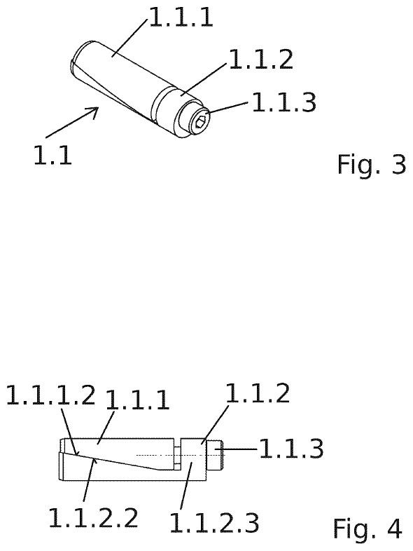

FIG. 3 shows, in perspective, the counter-stop for the positioning device according to FIG. 1; and

FIG. 4 shows, in side view, the counter-stop according to FIG. 3.

The positioning device illustrated in the figures initially consists in a known manner of a housing 1, an actuator 2 mounted for linear movement in the housing 1, a stop 2.1 provided on the actuator 2 and a counter-stop 1.1, which can be fixed in the housing 1 and interacts with the stop 2.1 to limit the stroke length of the actuator 2, wherein an insert opening 1.2 for the counter-stop 1.1 is provided on the housing 1.

It is preferably provided thereby that the actuator 2 is formed to optionally be driven by an electric motor, in a pneumatic or hydraulic manner; this drive is in each case illustrated on the bottom in FIGS. 1 and 2.

It is additionally preferably provided that the stop 2.1 is formed to optionally be screwed into the actuator 2 and/or so as to protrude in a cone-shaped manner from the actuator 2.

Viewed geometrically, it is further preferably provided that a main longitudinal axis of the counter-stop 1.1 is formed at a right angle to a main longitudinal axis of the actuator 2, but laterally offset thereto. It is furthermore additionally or alternatively preferably provided that a main longitudinal axis of the stop 2.1 is formed at a right angle to a main longitudinal axis of the actuator 2 and so as to intersect with it.

It is now essential for the solution according to the invention that the counter-stop 1.1 has two wedge elements 1.1.1, 1.1.2, which can be adjusted relative to one another and can thereby be fixed in the insert opening 1.2.

A screw element 1.1.3 for the connection of the two wedge elements 1.1.1, 1.1.2 is thereby furthermore provided. A threaded bore 1.1.1.1 is furthermore preferably provided on one of the two wedge elements 1.1.1 and a through bore 1.1.2.1 for the screw element 1.1.3 on the other one of the two wedge elements 1.1.2. Viewed geometrically, it thereby preferably applies that the threaded bore 1.1.1.1, the through bore 1.1.2.1 and the screw element 1.1.3 are formed so as to share a common longitudinal axis.

As can be seen from the figures, it is preferably provided with all this that the threaded bore 1.1.1.1 is arranged on a thicker end of the wedge element 1. 1. 1. It is further preferably provided that a screw element holder 1.1.2.3, which is provided with the through bore 1.1.2.1, is arranged on a thinner end of the wedge element 1.1.2.

To use the so-called self-locking (see also https://de.wikipedia.org/w/index.php?tile=Selbsthemmung&oldid=224834918), it is further and in particular with reference to FIG. 4 preferably provided that a friction surface 1.1.1.2 provided on the one wedge element 1.1.1 is formed so to interact with a friction surface 1.1.2.2 provided on the other wedge element 1.1.2. It is thereby furthermore preferably provided that the friction surfaces 1.1.1.2, 1.1.2.2 are formed so as to run obliquely to the longitudinal axis of the screw element 1.1.3.

It is furthermore preferably provided, as can be seen particularly well from FIG. 3, that the counter-stop 1.1 as a whole has an approximately cylindrical outer contour. It is accordingly further preferably provided that the insert opening 1.2 (on the housing 1) is formed as cylindrical bore, see in particular FIG. 2 with regard to this. Several insert openings 1.2 for the counter-stop 1.1 are thereby further preferably provided on the housing 1.

As can be seen from FIGS. 1 and 2, a slot 1.3, which runs parallel to a main axis of the actuator 2 with its longitudinal extension and which ensures an unhindered movement of the stop 2.1, is furthermore preferably provided on the housing 1. A guide element 1.4, which runs on both sides of the stop 2.1, is thereby preferably arranged in the slot 1.3. This guide element 1.4 is thereby preferably made of a harder material than the housing 1. For the further stability increase, preferably at least one through opening 1.4.1 for the counter-stop 1.1 is additionally provided on the guide element 1.4.

Finally, the assembly or disassembly, respectively, of the counter-stop 1.1 according to the invention works as follows:
Step 1: the pre-assembled counter-stop 1.1 is inserted into the insert opening 1.2 until it stops. However, the screw element 1.1.3 is thereby not yet t screwed in so far, as illustrated in FIG. 4.
Step 2: to establish a frictional connection between the friction surfaces 1.1.1.2, 1.1.2.2, the one wedge element 1.1.1 is wedged with the other wedge element 1.1.2 by application of a force onto the screw element 1.1.3 (the circumference of the counter-stop 1.1 becomes or is enlarged thereby, respectively). The force can be applied thereby, for example, by means of a blow with a hammer or with a press onto the screw element 1.1.3.
Step 3: the screw element 1.1.3 is—in order to eliminate a possible interference contour—preferably screwed so far into the threaded bore 1.1.1.1, until it no longer protrudes from the insert opening 1.2. The counter-stop 1.1 according to the invention is now fixed and thus ready for use.
Step 4: if the positioning device is to now be adapted as part of a stroke length adjustment, the screw element 1.1.3 is screwed in even further, whereby the wedge element 1. 1.1 moves in the direction of the screw element holder 1.1.2.3 and the frictional connection between the friction surfaces 1.1.1.2, 1.1.2.2 is released (the circumference of the counter-stop 1.1 decreases again thereby).
Step 5: the counter-stop 1.1 can finally be removed from or knocked out of the housing 1, respectively, for example by pulling on the screw element 1.1.3 or also by means of a so-called drift punch (the additional opening on the housing 1, which can be seen in FIG. 1, is provided for this purpose) and a readjustment can optionally carried out.

### LIST OF REFERENCE NUMERALS

1 housing
1.1 counter-stop
1.1.1 wedge element
1.1.1.1 threaded bore
1.1.1.2 friction surface
1.1.2 wedge element
1.1.2.1 through bore
1.1.2.2 friction surface
1.1.2.3 screw element holder
1.1.3 screw element
1.2 insert opening
1.3 slot
1.4 guide element
1.4.1 through opening
2 actuator
2.1 stop

1. A positioning device, comprising a housing (1), an actuator (2) mounted for linear movement in the housing (1), a stop (2.1) provided on the actuator (2) and a counter-stop (1.1), which can be fixed in the housing (1) and interacts with the stop (2.1) to limit the stroke length of the actuator (2), wherein an insert opening (1.2) for the counter-stop (1.1) is provided on the housing (1),
wherein the counter-stop (1.1) has two wedge elements (1.1.1, 1.1.2), which can be adjusted relative to one another and can thereby be fixed in the insert opening (1.2).

2. The positioning device according to claim 1,
wherein a screw element (1.1.3) for the connection of the two wedge elements (1.1.1, 1.1.2) is provided.

3. The positioning device according to claim 2,
wherein a threaded bore (1.1.1.1) is provided on one of the two wedge elements (1.1.1) and a through bore (1.1.2.1) for the screw element (1.1.3) on the other one of the two wedge elements (1.1.2).

4. The positioning device according to claim 3,
wherein the threaded bore (1.1.1.1), the through bore (1.1.2.1) and the screw element (1.1.3) are formed so as to share a common longitudinal axis.

5. The positioning device according to claim 3,
wherein the threaded bore (1.1.1.1) is arranged on a thicker end of the wedge element (1.1.1).

6. The positioning device according to claim 3,
wherein a screw element holder (1.1.2.2), which is provided with the through bore (1.1.2.1), is arranged on a thinner end of the wedge element (1.1.2).

7. The positioning device according to claim 1,
wherein a friction surface (1.1.1.2) provided on the one wedge element (1.1.1) is formed so as to interact with a friction surface (1.1.2.2) provided on the other wedge element (1.1.2).

8. The positioning device according to claim 2,
wherein the friction surfaces (1.1.1.2, 1.1.2.2) are formed so as to run obliquely to the longitudinal axis of the screw element (1.1.3).

9. The positioning device according to claim 1,
wherein the counter-stop (1.1) as a whole has an approximately cylindrical outer contour.

10. The positioning device according to claim 1,
wherein the insert opening (1.2) is formed as a cylindrical bore.
